(19) United States
(12) Patent Application Publication
(10) Pub. No.: US 2025/0019533 A1
(43) Pub. Date: Jan. 16, 2025

(54) COMPOSITION OF THERMOPLASTIC POLYMER, PLASTICIZER, AND LOW MELTING POLYMER

(71) Applicant: Avient Corporation, Avon Lake, OH (US)

(72) Inventors: Ren Ivins, Marietta, GA (US); Anna Nastase, Marietta, GA (US); Tristan Van Vuuren, Davidson, NC (US); Will Marks, Carrollton, GA (US)

(73) Assignee: Avient Corporation, Avon Lake, OH (US)

(21) Appl. No.: 18/770,808

(22) Filed: Jul. 12, 2024

Related U.S. Application Data
(60) Provisional application No. 63/526,923, filed on Jul. 14, 2023.

(51) Int. Cl. C08L 27/06; C08K 3/22; C08K 5/00

(52) U.S. Cl. CPC C08L 27/06; C08K 3/22; C08K 5/0016; C08K 2003/2241

(57) ABSTRACT

A composition includes a thermoplastic polymer, a plasticizer, and about 0.2 wt % to about 19 wt % of a low melting polymer, based on a total weight of the composition. The low melting polymer has a melting point less than about 120° C. The resulting composition requires a lower temperature to full cure, while still maintaining long-term storage stability.

### CLAIM OF PRIORITY

This application claims priority from U.S. Provisional Patent Application Ser. No. 63/526,923 bearing Attorney Docket Number 1202311-US-F and filed on Jul. 14, 2023, which is hereby incorporated by reference in its entirety.

### TECHNICAL FIELD

Embodiments of the present disclosure are generally related to compositions, and are specifically related to compositions including a thermoplastic polymer, a plasticizer, and a low melting polymer.

### BACKGROUND

Plastisols, suspensions of polymeric particles in plasticizers, are used in a wide variety of applications, such as metal, outdoor, automotive, and screen-printed products, due to their ease of processing and ability to cure into flexible solids. However, conventional plastisols often require high temperature treatment to fully cure and achieve sufficient adhesion and durability, which may be energy-intensive and/or increase costs.

Accordingly, a need exists for a new plastisol composition that requires lower temperature or reduced exposure time to full cure, while still maintaining long-term storage stability.

### SUMMARY

Embodiments of the present disclosure are directed to compositions including a thermoplastic polymer, a plasticizer, and a low melting polymer.

According to one embodiment, a composition is provided. The composition comprises a thermoplastic polymer; a plasticizer; and about 0.2 wt % to about 19 wt % of a low melting polymer, based on a total weight of the composition. The low melting polymer has a melting point less than about 120° C.

Additional features and advantages of the embodiments described herein will be set forth in the detailed description which follows, and in part will be readily apparent to those skilled in the art from that description or recognized by practicing the embodiments described herein, including the detailed description, which follows and the claims.

### BRIEF DESCRIPTION OF DRAWINGS

FIG. 1 is a schematic view of an article, according to one or more embodiments described herein;

FIG. 2 is a plot of S′ (y-axis; in dNm) versus temperature (x-axis; in ° C.) of a comparative composition and example compositions, according to one or more embodiments described herein;

FIG. 3 is a plot of S′ (y-axis; in dNm) versus temperature (x-axis; in ° C.) of comparative compositions and example compositions, according to one or more embodiments described herein;

FIG. 4 is a plot of time (x-axis; in days) versus viscosity (y-axis; in cP) of comparative compositions and an example composition, according to one or more embodiments described herein;

FIG. 5 is a plot of time (x-axis; in days) versus viscosity (y-axis; in cP) of comparative compositions and an example composition, according to one or more embodiments described herein.

FIG. 6 is a plot of time (x-axis; in days) versus viscosity (y-axis; in cP) of comparative compositions and example compositions, according to one or more embodiments described herein.

### DETAILED DESCRIPTION

Reference will now be made in detail to various embodiments of compositions, specifically compositions comprising a thermoplastic polymer; a plasticizer; and about 0.2 wt % to about 19 wt % of a low melting polymer, based on a total weight of the composition. The low melting polymer has a melting point less than about 120° C.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by a person of ordinary skill in the art. The terminology used in the disclosure herein is for describing particular embodiments only and is not intended to be limiting.

Unless otherwise expressly stated, it not intended that any method disclosed herein be construed as requiring that its steps be performed in a specific order, nor that any article set forth herein be construed as requiring specific orders or orientations to its individual components.

Unless otherwise expressly stated, it is intended that any composition or mixture disclosed herein may comprise, consist essentially of, or consist of the disclosed components.

As used herein, the singular form of a term is intended to include the plural form of the term, unless the context clearly indicates otherwise.

As used herein, numerical values are not strictly limited to the exact numerical value recited. Instead, unless otherwise expressly stated, each numerical value is intended to mean both the exact numerical value and “about” the numerical value, which encompasses a functionally equivalent range surrounding that numerical value, such that either possibility is contemplated as an embodiment disclosed herein.

As used herein, the term “S′” refers to a torque value of a material as measured with a moving die rheometer and is provided in units of Deci Newton Meters (“dNm”). A relatively greater S′ corresponds to a relatively greater material stiffness. A test sample is prepared by sandwiching approximately 5 grams of material between two polyester films and loading the material onto the lower die. The upper geometry is then lowered and the uncured material is pressed between the two dies in the test chamber. A constant strain of 0.5 degrees and oscillation frequency of 1.67 Hz is applied while the sample is heated from 50° C. to 160° C. at a rate of 5° C. per minute. The liquid to solid transition is plotted in real time as the sample cures with increasing temperature.

As used herein, the terms “maximum S′” and “max S” refer to the peak S′.

As used herein, the terms “full cure” and “fully cured” refer to the point at which a material reaches max S′ (i.e., the material is 100% cured).

As used herein, the term “cure temperature” refers to the temperature at max S′.

As used herein, the term “measured cure time” refers to the amount of time it takes a material to reach max S′ when heated at a temperature at or above the cure temperature.

“Cure temperature” and “measured cure time,” as defined herein, are dependent on the test method and parameters described herein used to measure S′. One skilled in the art would appreciate that a different test method and/or parameters may result in a different measured S′, and thus, a different cure temperature and cure time.

As used herein, the term “10% S′” refers to the point at which a material reaches 10% of max S′ (i.e., the material is 10% cured).

As used herein, the term “50% S′” refers to the point at which a material reaches 50% of max S′ (i.e., the material is 50% cured).

As used herein, the term “90% S′” refers to the point at which a material reaches 90% of max S′ (i.e., the material is 90% cured).

As used herein, the term “maintained storage stability” refers to less than 200% viscosity change when aged at 35° C. for 28 days (i.e., (viscosity on Day 28/viscosity on Day 1)×100<200%).

As used herein, the term “viscosity” refers to viscosity as measured according to ASTM D1824 at 2.5 RPM and 25° C.

As used herein, the term “plastisol” refers to compositions comprising polymer particles suspended in liquid plasticizer. Plastisol dispersions are liquids that cure to flexible, rubber-like solids. When heated above the glass transition temperature of the plastic, the plasticizer is absorbed into the polymer matrix, forming a gel and eventually a fused solid at higher temperatures.

As used herein, the term “homopolymer” refers to a polymer having repeating units of a single type of monomer.

As used herein, the term “copolymer” refers to a polymer having repeating units of two or more types of monomers.

As used herein, the term “melting point” is measured according to ASTM D3418.

As used herein, the term “particle size” refers to the mean diameter, in micrometers, of the monodispersed resin particles.

As discussed hereinabove, due to their storage stability and desirable adhesion and durability, plastisols have many uses including, but not limited to, coatings, binders, adhesives, sealants, and protective layers, in a wide variety of applications, such as protective coatings for metal finishes, ultraviolet films for outdoor products, automotive products, and textile inks for screen-printing. Conventional plastisols that are storage stable require high heat treatment to fully cure, which may be energy-intensive and/or increase costs.

Plastisol compositions may work in various areas, including, but not limited to, metal finish coatings, automobile applications, and screen-printing applications. Specifically, screen-printing inks is one application where the composition needs to be storage stable for a long period of time before use.

For example, to screen-print a plastisol ink, heat and/or pressure is applied to cure the plastisol onto a textile surface to prepare a final product. Conventionally, textile screen-printing involves three steps: (1) printing the plastisol ink on the textile surface; (2) heating to a lower curing temperature that allows the printed plastisol ink to sufficiently dry the top surface(s) of the printed plastisol ink to allow for printing of additional layers; and (3) conveying the lower temperature cured plastisol ink through a conveyor oven to fully cure the plastisol ink. While step (3) helps to achieve sufficient adhesion and durability, it may be an energy-intensive, time-intensive, and/or financially costly step. Smaller screen printers that do not have access to industrial ovens may cure the printed plastisol ink using only short bursts of intense heat from a smaller heating unit (e.g., a radiant heater). But, this may require relatively higher temperatures and long times (e.g., 175° C. for 10 seconds), which may not be industrially scalable.

Disclosed herein are compositions. Specifically, the compositions disclosed herein include a thermoplastic polymer, a plasticizer, and a low melting polymer. The low melting polymer has a relatively low melting point (e.g., less than about 120° C.), and, advantageously, helps to reduce the cure temperature (e.g., less than or equal to about 115° C.) while maintaining storage stability (i.e., less than 200% viscosity change when aged at 35° C. for 28 days). Reducing cure temperature and cure time allows for reduced energy input, lower cost, and increased throughput.

Accordingly, the compositions disclosed herein may be used to form any coating, binder, adhesive, sealant, protective layer, or the like that requires a cure temperature of less than or equal to about 115° C. and a measured cure time of less than about 10 seconds. The compositions disclosed herein are especially useful for making protective coatings for metal finishes, ultraviolet films for outdoor products, automotive products, and textile inks for screen-printing.

The compositions disclosed herein may generally be described as comprising a thermoplastic polymer, a plasticizer, and a low melting polymer.

### Thermoplastic Polymer

As described hereinabove, the compositions comprise a thermoplastic polymer suspended in the plasticizer. The thermoplastic polymer imparts the mechanical structure of cured coating. The selection of the thermoplastic polymer may impact the rheology of the plastisol, the cure dynamics, and the flexibility and durability of the coating.

In embodiments, the thermoplastic polymer may comprise a polyvinyl chloride homopolymer, polyvinyl chloride and vinyl ester copolymer, or a combination thereof. In embodiments, the polyvinyl chloride and vinyl ester copolymer may have less than 5 wt % vinyl ester. In embodiments, the thermoplastic polymer may be a combination of polyvinyl chloride homopolymer and polyvinyl chloride and vinyl ester copolymer. In such embodiments, a weight ratio of polyvinyl chloride and vinyl ester copolymer to polyvinyl chloride homopolymer, based on a total weight of the composition, may be from about 1:1 to about 10:1. While not wishing to be bound by theory, polyvinyl chloride and vinyl ester copolymer fully cures at relatively low temperatures as compared to polyvinyl chloride homopolymer. Accordingly, a relatively greater amount of polyvinyl chloride and vinyl ester copolymer as compared to polyvinyl chloride homopolymer may be included in the composition to help achieve a fully cured composition at a relatively lower temperature (e.g., temperature at max S′ of less than or equal to 115° C.). In embodiments, a weight ratio of polyvinyl chloride and vinyl ester copolymer to polyvinyl chloride homopolymer, based on a total weight of the composition, may be from about 1:1 to about 10:1, from about 1:1 to about 8:1, from about 1:1 to about 6:1, from about 1:1 to about 4:1, from about 2:1 to about 10:1, from about 2:1 to about 8:1, from about 2:1 to about 6:1, or even from about 2:1 to about 4:1, or any and all subranges formed from any of these endpoints.

In embodiments, the thermoplastic polymer may comprise an acrylic resin. In embodiments, the acrylic resin may be essentially free of polyvinyl halides. In embodiments, the acrylic resin may include methacrylate copolymers as core/shell copolymers. In embodiments, the core of the copolymer may be a copolymer of methyl methacrylate (MMA) monomer and butyl methacrylate (BMA) monomer, i.e., PMMA-PBMA copolymer. In embodiments, the shell of the copolymer may be a homopolymer of MMA, i.e., PMMA.

The glass transition temperature (Tg) of the methacrylate copolymer, as measured using DSC at a ramp rate of 10° C./min displays two peaks: one for the PMMA-rich shell occurring at a temperature between 110° C. and 125° C., and a second peak for the PMMA-PBMA core occurring at a temperature between 85° C. and 105° C. The volume ratio of the core-to-shell may be in the range from 1:3 to 3:1. The number average molecular weight, Mn, of the copolymer resin may be from 160,000 to 350,000, as measured using high performance size exclusion chromatography, relative to polystyrene, with a polydispersity Mw/Mn between 3.0 and 6.0.

In embodiments, the methacrylate copolymer may be in the form of bead polymers, pellets, granules, powders, or spray dried emulsion polymers.

In embodiments, the composition may include a minimum amount of the thermoplastic polymer (e.g., greater than or equal to about 20 wt %) to ensure that a desired form (e.g., coating, binder, adhesive, sealant, protective layer) is achieved. In embodiments, the amount of the thermoplastic polymer may be limited (e.g., less than or equal to about 45 wt %) as more thermoplastic polymer may require more plasticizer. As described herein, the amount of plasticizer in the composition may be limited (e.g., less than or equal to about 45 wt %) to ensure a consistent form (e.g., coating, binder, adhesive, sealant, protective layer) is achieved. Accordingly, in embodiments, the composition may comprise, based on a total weight of the composition, about 20 wt % to about 45 wt % of the thermoplastic polymer. In embodiments, the amount of the thermoplastic polymer in the composition may be, based on a total weight of the composition, greater than or equal to about 20 wt %, greater than or equal to about 23 wt %, greater than or equal to about 25 wt %, greater than or equal to about 27 wt %, or even greater than or equal to about 30 wt %. In embodiments, the amount of the thermoplastic polymer in the composition may be, based on a total weight of the composition, less than or equal to about 45 wt %, less than or equal to about 43 wt %, less than or equal to about 40 wt %, less than or equal to about 37 wt %, or even less than or equal to about 35 wt %. In embodiments, the amount of the thermoplastic polymer in the composition may be, based on a total weight of the composition, from about 20 wt % to about 45 wt %, from about 20 wt % to about 43 wt %, from about 20 wt % to about 40 wt %, from about 20 wt % to about 37 wt %, from about 20 wt % to about 35 wt %, from about 23 wt % to about 45 wt %, from about 23 wt % to about 43 wt %, from about 23 wt % to about 40 wt %, from about 23 wt % to about 37 wt %, from about 23 wt % to about 35 wt %, from about 25 wt % to about 45 wt %, from about 25 wt % to about 43 wt %, from about 25 wt % to about 40 wt %, from about 25 wt % to about 37 wt %, from about 25 wt % to about 35 wt %, from about 27 wt % to about 45 wt %, from about 27 wt % to about 43 wt %, from about 27 wt % to about 40 wt %, from about 27 wt % to about 37 wt %, from about 27 wt % to about 35 wt %, from about 30 wt % to about 45 wt %, from about 30 wt % to about 43 wt %, from about 30 wt % to about 40 wt %, from about 30 wt % to about 37 wt %, or even from about 30 wt % to about 35 wt %, or any and all subranges formed from any of these endpoints.

In embodiments, the thermoplastic polymer may be an emulsion or a dispersion grade. In such embodiments, the thermoplastic polymer may have a particle size greater than or equal to 0.2 μm, greater than or equal to about 0.5 μm, or even greater than or equal to about 1 μm. In embodiments, the thermoplastic polymer may have a particle size less than or equal to about 15 μm, less than or equal to about 10 μm, or even less than or equal to about 5 μm. In embodiments, the thermoplastic polymer may have a particle size from about 0.2 μm to about 15 μm, from about 0.2 μm to about 10 μm, from about 0.2 μm to about 5 μm, from about 0.5 μm to about 15 μm, from about 0.5 μm to about 10 μm, from about 0.5 μm to about 5 μm, from about 1 μm to about 15 μm, from about 1 μm to about 10 μm, or even from about 1 μm to about 5 μm, or any and all subranges formed from any of these endpoints.

Suitable commercial embodiments of the thermoplastic polymer include VICIR E1970P, VESTOLIT G124A, VESTOLIT G121A, VESTOLIT G173, VESTOLIT G186A, FORMOLON KVF, VINNOLIT E69VS, INOVYN P709, VESTOLIT 1353K, INOVYN 370HD, INOVYM 372NF, VINNOLIT P70, FORMOLON 10, VESTOLIT G138, VESTOLIT G136, FORMOLON 45, KANEKA PCH-12, VESTOLIT B7090, FORMOLON 40, and DIANAL RB2948.

### Plasticizer

As described hereinabove, the compositions comprise a plasticizer within which the thermoplastic polymer is suspended. Suitable plasticizers for use in the compositions of the present disclosure include those plasticizers that form a liquid dispersion when combined with the thermoplastic polymer. Upon heating, the plasticizer penetrates or migrates into the thermoplastic polymer, causing the thermoplastic polymer to swell and form a gel. After cooling, the resultant product is a permanently plasticized solid product.

Suitable plasticizers for use in the compositions described herein may be relatively highly solvating and be more likely to penetrate into the thermoplastic polymer. Solvation of a polymer may be effected by the plasticizer's molecular weight and functional groups. For example, a higher molecular weight may generally result in a higher viscosity, which may result in relatively lower solvating potential.

In embodiments, the plasticizer may comprise terephthalate, cyclohexonate, benzoate, dibenzoate, adipate, citrate, trimelitate, alkyl sufonic acid ester, or a combination thereof. In embodiments, the terephthalate may comprise dibutyl terephthalate, dioctyl terephthalate, or a combination thereof. In embodiments, the cyclohexonate may comprise benzyl 3-(isobutyryloxy)-2,2,4-trimethylpentyl cyclohexane-1,2-dicarboxylate, butyl benzyl cyclohexanoate; texanol benzy cyclohexanoate, 1,2-cyclohexane dicarboxylic acid diisononyl ester, 1,2-cyclohexanedicarboxylic acid, 1-(phenylmethyl) ester, ester with 2,2,4-trimethyl-1,3-pentanediol mono(2-methylpropanoate), or a combination thereof. In embodiments, the dibenzoate may comprise 2,2,4-trimethyl-1,3-pentanediol, dibenzoate.

In embodiments, the plasticizer may comprise dibutyl terephthalate; dioctyl terephthalate; benzyl 3-(isobutyryloxy)-2,2,4-trimethylpentyl cyclohexane-1,2-dicarboxylate; butyl benzyl cyclohexanoate; texanol benzy cyclohexanoate; 1,2-cyclohexane dicarboxylic acid diisononyl ester; 2,2,4-trimethyl-1,3-pentanediol, dibenzoate; 1,2-cyclohexanedicarboxylic acid, 1-(phenylmethyl) ester, ester with 2,2,4-trimethyl-1,3-pentanediol mono(2-methylpropanoate), or a combination thereof.

In embodiments, the plasticizer may comprise dioctyl terephthalate; dibutyl terephthalate; and 1,2-cyclohexanedicarboxylic acid, 1-(phenylmethyl) ester, ester with 2,2,4-trimethyl-1,3-pentanediol mono(2-methylpropanoate). In such embodiments, a weight ratio of dioctyl terephthalate to dibutyl terephthalate to 1,2-cyclohexanedicarboxylic acid, 1-(phenylmethyl) ester, ester with 2,2,4-trimethyl-1,3-pentanediol mono(2-methylpropanoate) may be, based on a total weight of the composition, from about 0.28:0.12:1.00 to about 0.7:0.3:1.0.

In embodiments, a minimum amount of plasticizer (e.g., greater than or equal to about 20 wt %) to ensure a liquid property is imparted to the composition. In embodiments, the amount of plasticizer in the composition may be limited (e.g., less than or equal to about 45 wt %) to ensure a consistent form (e.g., coating, binder, adhesive, sealant, protective layer) is achieved. In embodiments, the composition may comprise, based on a total weight of the composition, about 20 wt % to about 45 wt % of the plasticizer. In embodiments, the amount of the plasticizer in the composition may be, based on a total weight of the composition, greater than or equal to about 20 wt %, greater than or equal to about 23 wt %, greater than or equal to about 25 wt %, greater than or equal to about 27 wt %, greater than or equal to about 30 wt %, or even greater than or equal to about 33 wt %. In embodiments, the amount of the plasticizer in the composition may be, based on a total weight of the composition, less than or equal to about 45 wt %, less than or equal about 43 wt %, less than or equal to about 40 wt %, or even less than or equal to about 37 wt %. In embodiments, the amount of the plasticizer in the composition may be, based on a total weight of the composition, from about 20 wt % to about 45 wt %, from about 20 wt % to about 43 wt %, from about 20 wt % to about 40 wt %, from about 20 wt % to about 37 wt %, from about 23 wt % to about 45 wt %, from about 23 wt % to about 43 wt %, from about 23 wt % to about 40 wt %, from about 23 wt % to about 37 wt %, from about 25 wt % to about 45 wt %, from about 25 wt % to about 43 wt %, from about 25 wt % to about 40 wt %, from about 25 wt % to about 37 wt %, from about 27 wt % to about 45 wt %, from about 27 wt % to about 43 wt %, from about 27 wt % to about 40 wt %, from about 27 wt % to about 37 wt %, from about 30 wt % to about 45 wt %, from about 30 wt % to about 43 wt %, from about 30 wt % to about 40 wt %, from about 30 wt % to about 37 wt %, from about 33 wt % to about 45 wt %, from about 33 wt % to about 43 wt %, from about 33 wt % to about 40 wt %, or even from about 33 wt % to about 37 wt %, or any and all subranges formed from any of these endpoints.

Suitable commercial embodiments of the plasticizer include EASTMAN 168 (DOTP), EASTMAN DBT, VERSMAX PLUS (DOTP and DBT), SANTICIZER P1700, SANTICIZER P1400, HEXAMOL DINCH, DEHCH, BENZOFLEX 354, BENZOFLEX 2088, BENZOFLEX 1046, BENZOFLEX 9-88, SYNOPLAST DOA-FM, SYNOPLAST TOTM, VIXOFLEX 7170, CITROFLEX AH2, CITROFLEX A-6, and MESAMOLL.

### Low Melting Polymer

As described hereinabove, the compositions include a low melting polymer that helps to reduce cure temperature (e.g., less than or equal to about 115° C.) while maintaining storage stability (i.e., less than 200% viscosity change when aged at 35° C. for 28 days) While not wishing to be bound by theory, it is believed that the low melting polymer having a relatively low melting point (e.g., less than about 120° C.) melts and helps blend the entire composition together, thereby lowering the temperature at which the composition is fully cured.

In embodiments, the low melting polymer may have a melting point less than about 120° C. promotes adhesion and helps to fully cure the composition at a relatively low temperature (e.g., temperature at max S′ of less than or equal to about 115° C.). In embodiments, the low melting polymer may have a melting point less than about 120° C., less than about 110° C., less than about 100° C., or even less than or equal to about 90° C. In embodiments, the low melting polymer may have a melting point of greater than or equal to about 80° C. to ensure viscosity stability of the composition. Accordingly, in embodiments, the low melting polymer may have a melting from about 80° C. to about 120° C., from about 80° C. to about 110° C., from about 80° C. to about 100° C., or even from about 80° C. to about 90° C., or any and all subranges formed from any of these endpoints.

In embodiments, the low melting polymer may comprise polyester, copolyester, copolyamide, polyamide, thermoplastic polyurethane, or a combination thereof.

In embodiments, the composition may comprise a minimum amount of low melting polymer (e.g., greater than or equal to about 0.2 wt %) to ensure reduced cure temperature and time. The greater the amount of the low melting polymer, the closer the cure temperature of the composition will be to the low melting polymer's melting point. The amount of low melting polymer in the composition may be limited (e.g., less than or equal to about 19 wt %) in certain applications due to effects on viscosity. For example, in a screen-printing application, if the low melting polymer has a large particle size distribution, it may have poor printability and leave residue on the screen if the amount of low melting polymer is too high. Accordingly, the composition may comprise, based on a total weight of the composition, about 0.2 wt % to about 19 wt % of the low melting polymer. In embodiments, the amount of the low melting polymer in the composition may be, based on a total weight of the composition, greater than or equal to about 0.2 wt %, greater than or equal to about 0.5 wt %, greater than or equal to about 1 wt %, or even greater than or equal to about 2 wt %. In embodiments, the amount of the low melting polymer in the composition may be, based on a total weight of the composition, less than or equal to about 19 wt %, less than or equal to about 17 wt % less than or equal to about 15 wt %, less than or equal to about 13 wt %, less than or equal to about 10 wt %, less than or equal to about 7 wt %, or even less than or equal to about 5 wt %. In embodiments, the amount of the low melting polymer in the composition may be, based on a total weight of the composition, from about 0.2 wt % to about 19 wt %, from about 0.2 wt % to about 17 wt %, from about 0.2 wt % to about 15 wt %, from about 0.2 wt % to about 13 wt %, from about 0.2 wt % to about 10 wt %, from about 0.2 wt % to about 7 wt %, from about 0.2 wt % to about 5 wt %, from about 0.5 wt % to about 19 wt %, from about 0.5 wt % to about 17 wt %, from about 0.5 wt % to about 15 wt %, from about 0.5 wt % to about 13 wt %, from about 0.5 wt % to about 10 wt %, from about 0.5 wt % to about 7 wt %, from about 0.5 wt % to about 5 wt %, from about 1 wt % to about 19 wt %, from about 1 wt % to about 17 wt %, from about 1 wt % to about 15 wt %, from about 1 wt % to about 13 wt %, from about 1 wt % to about 10 wt %, from about 1 wt % to about 7 wt %, from about 1 wt % to about 5 wt %, from about 2 wt % to about 19 wt %, from about 2 wt % to about 17 wt %, from about 2 wt % to about 15 wt %, from about 2 wt % to about 13 wt %, from about 2 wt % to about 10 wt %, from about 2 wt % to about 7 wt %, or even from about 2 wt % to about 5 wt %, or any and all subranges formed from any of these endpoints.

In embodiments, the low melting polymer may be substantially nonpolar and have a relatively small particle size to form a stable dispersion in the plasticizer. In embodiments, the low melting polymer may have a particle size from greater than 0 μm to about 80 μm, from greater than 0 μm to about 60 μm, from greater than 0 μm to about 40 μm, from greater than 0 μm to about 20 μm, from about 5 μm to about 80 μm, from about 5 μm to about 60 μm, from about 5 μm to about 40 μm, from about 5 μm to about 20 μm, from about 10 μm to about 80 μm, from about 10 μm to about 60 μm, from about 10 μm to about 40 μm, or even from about 10 μm to about 20 μm, or any and all subranges formed from any of these endpoints.

Suitable commercial embodiments of the low melting polymer include PES T3, PES 376, PES E20, PES 3320, GRILLTEX 83, PA5005, PA5350, PA5720, GRILTEX 1A, GRILTEX 11A, TPU 4046, and TPU 4073.

### Colorant, Pigment, and Dye

In embodiments, the composition may further comprise at least one of a colorant, pigment, and dye to impart color the composition. In embodiments, the at least one of a colorant, pigment, and dye may comprise titanium dioxides (e.g., for white), carbon blacks (e.g., for black), azo pigments (e.g., for reds, oranges, and/or yellows), copper phthalocyanine pigments (e.g., for blues and/or greens), carbozoles (e.g., for violet), or a combination thereof. In embodiments, the pigment may comprise titanium dioxide.

In embodiments, the composition may comprise, based on the total weight of the composition, greater than about 0 wt % to about 45 wt % of the at least one of colorant, pigment, and dye. In embodiments, the amount of the at least one of colorant, pigment, and dye in the composition may be, based on a total weight of the composition, greater than or equal to about 0 wt %, greater than or equal to about 5 wt %, greater than or equal to about 10 wt %, greater than or equal to about 15 wt %, greater than or equal to about 20 wt %, or even greater than or equal to about 25 wt %. In embodiments, the amount of the at least one of colorant, pigment, and dye may be less than or equal to about 45 wt %, less than or equal to about 40 wt %, or even less than or equal to about 35 wt %. In embodiments, the amount of the at least one of colorant, pigment, and dye may be, based on a total weight of the composition, from about 0 wt % to about 45 wt %, from about 0 wt % to about 40 wt %, from about 0 wt % to about 35 wt %, from about 5 wt % to about 45 wt %, from about 5 wt % to about 40 wt %, from about 5 wt % to about 35 wt %, from about 10 wt % to about 45 wt %, from about 10 wt % to about 40 wt %, from about 10 wt % to about 35 wt %, from about 15 wt % to about 45 wt %, from about 15 wt % to about 40 wt %, from about 15 wt % to about 35 wt %, from about 25 wt % to about 45 wt %, from about 25 wt % to about 40 wt %, or even from about 25 wt % to about 35 wt %, or any and all subranges formed from any of these endpoints.

Suitable commercial embodiments of the colorant, pigment, and dye include TIONA 244, RCLA, TRONOX CR-828, TRONOX CR-880, TONOX CR-826, TI-PURE TS-6300, TIONA 242, TIONA 880, TIONA 595, NUBIX E62 ULTRAMARINE BLUE F 36 ULTRAMARINE BLUE, REGAL 400R, CAP 3422C ORANGE/LANSCO ORANGE 34 1334 (50:50), HELIOGEN BLUE K6911D, HEUCO BLUE PB515303, 264-8142 SUNFAST GREEN, BONITHOL RED 4821C, LANSCO 1657 LITHOL RUBINE 57:1, JHR-1220L, HOSTAPERM RED E3B (13-7002), 246-0505 SUNFAST VIOLET 23, HEUCO PY101404 YELLOW 14/YELLOW TCY-014020, JHY-8307L, HOSTAPERM YELLOW H4G (11-3020), BLACK 7, ORANGE 34, BLUE 15:1, BLUE 15:3, GREEN 7, RED 48:2, RED 57:1, RED 122, VIOLET 19, VIOLET 23, YELLOW 14, YELLOW 83, and YELLOW 151.

### Additives

In embodiments, the composition may further comprise additives. In embodiments, the additives may comprise dispersants, fillers, lubricants, optical brighteners, puff matting agents, antioxidants, chemical and physical blowing agents, stabilizers, moisture scavengers, air release agents, oxidizers, reducers, thickeners, emulsifiers, rheology modifiers, catalysts, or a combination thereof.

In embodiments, the composition may comprise, based on a total weight of the composition, greater than about 0 wt % to about 10 wt % of the additives. In embodiments, the amount of the additives in the composition may be, based on a total weight of the composition, greater than or equal to about 0 wt %, greater than or equal to about 0.25 wt %, greater than or equal to about 0.5 wt %, greater than or equal to about 0.75 wt %, or even greater than or equal to about 1 wt %. In embodiments, the amount of the additives in the composition may be, based on a total weight of the composition, less than or equal to about 10 wt %, less than or equal to about 7 wt %, less than or equal to about 5 wt %, less than or equal to about 3 wt %, or even less than or equal to about 2 wt %. In embodiments, the amount of the additives in the composition may be, based on a total weight of the composition, from about 0 wt % to about 10 wt %, from about 0 wt % to about 7 wt %, from about 0 wt % to about 5 wt %, from about 0 wt % to about 3 wt %, from about 0 wt % to about 2 wt %, from about 0.25 wt % to about 10 wt %, from about 0.25 wt % to about 7 wt %, from about 0.25 wt % to about 5 wt %, from about 0.25 wt % to about 3 wt %, from about 0.25 wt % to about 2 wt %, from about 0.5 wt % to about 10 wt %, from about 0.5 wt % to about 7 wt %, from about 0.5 wt % to about 5 wt %, from about 0.5 wt % to about 3 wt %, from about 0.5 wt % to about 2 wt %, from about 0.75 wt % to about 10 wt %, from about 0.75 wt % to about 7 wt %, from about 0.75 wt % to about 5 wt %, from about 0.75 wt % to about 3 wt %, from about 0.75 wt % to about 2 wt %, from about 1 wt % to about 10 wt %, from about 1 wt % to about 7 wt %, from about 1 wt % to about 5 wt %, from about 1 wt % to about 3 wt %, or even from about 1 wt % to about 2 wt %, or any and all subranges formed from any of these endpoints.

Suitable commercial embodiments of the additives include OMYACARB 3, OMYACARB 5, OBYACARB FT, ULTRAPFLEX H, ATOMITE, NICRON 503, STELLAR 705, SUPERCOAT, DURAMITE, AEROSIL200, SIPERNAT 28, SIPERNAT 22, ACEMAT TS100, BYK 7410ET, ICROGEL 900, IRCOGEL 903, DISPERBYK 180, DISPERBYK 2150 DISPERPLAST 1150, SPAN 85, PARAWHITE OB, BENETEX OB, VISCOGEL ED, BENTONE 40, DUALITE U024-145D, MIKROFINE OBSH-M300, ANDISIL SF 30,000, BYK 333, IRGANOX 1330, BYK-A 515, BYK-A 530, and BYK-A 555.

### Composition

As described herein, the compositions include a thermoplastic polymer, a plasticizer, and a low melting polymer, which have a relatively low cure temperature (e.g., less than or equal to about 115° C.) and maintained storage stability (i.e., less than 200% viscosity change when aged at 35° C. for 28 days).

In embodiments, the composition may have a cure temperature (i.e., temperature at maximum S′) less than or equal to about 115° C. In embodiments, the composition may have a cure temperature less than or equal to about 115° C., less than or equal to about 110° C., less than or equal to about 105° C., less than or equal to about 100° C., less than or equal to about 95° C., or even less than or equal to about 90° C. In embodiments, the composition may have a cure temperature greater than or equal to about 40° C., greater than or equal to about 50° C., or even greater than or equal to about 60° C. In embodiments, the composition may have a cure temperature from about 40° C. to about 115° C., from about 40° C. to about 110° C., from about 40° C. to about 105° C., from about 40° C. to about 100° C., from about 40° C. to about 95° C., from about 40° C. to about 90° C., from about 50° C. to about 115° C., from about 50° C. to about 110° C., from about 50° C. to about 105° C., from about 50° C. to about 100° C., from about 50° C. to about 95° C., from about 50° C. to about 90° C., from about 60° C. to about 115° C., from about 60° C. to about 110° C., from about 60° C. to about 105° C., from about 60° C. to about 100° C., from about 60° C. to about 95° C., or even from about 60° C. to about 90° C., or any and all subranges formed from any of these endpoints.

In embodiments, the composition may have a measured cure time less than or equal to about 500 seconds, less than or equal to about 450 seconds, or even less than or equal to about 400 seconds. In embodiments, the composition may have a measured cure time greater than or equal to about 100 seconds, greater than or equal to about 200 seconds, or even greater than or equal to about 300 seconds. In embodiments, the composition may have a measured cure time from about 100 seconds to about 500 seconds, from about 100 seconds to about 450 seconds, from about 100 seconds to about 400 seconds, from about 200 seconds to about 500 seconds, from about 200 seconds to about 450 seconds, from about 200 seconds to about 400 seconds, from about 300 seconds to about 500 seconds, from about 300 seconds to about 450 seconds, or even from about 300 seconds to about 400 seconds, or any and all subranges formed from any of these endpoints.

In embodiments, the composition may have a temperature at 10% S′ greater than or equal to about 50° C. or even greater than or equal to about 60° C. In embodiments, the composition may have a temperature at 10% S′ less than or equal to about 85° C. or even less than or equal to about 75° C. In embodiments, the composition may have a temperature at 10% S′ from about 50° C. to about 85° C., from about 50° C. to about 75° C., from about 60° C. to about 85° C., or even from about 60° C. to about 75° C., or any and all subranges formed from any of these endpoints.

In embodiments, the composition may have a time at 10% S′ greater than or equal to about 100 seconds or even greater than or equal to about 200 seconds. In embodiments, the composition may have a time at 10% S′ less than or equal to about 400 seconds or even less than or equal to about 300 seconds. In embodiments, the composition may have a time at 10% S′ from about 100 seconds to about 400 seconds, from about 100 seconds to about 300 seconds, from about 200 seconds to about 400 seconds, from about 200 seconds to about 300 seconds, or any and all subranges formed from any of these endpoints.

In embodiments, the composition may have a temperature at 50% S′ greater than or equal to about 55° C. or even greater than or equal to about 65° C. In embodiments, the composition may have a temperature at 50% S′ less than or equal to about 90° C. or even less than or equal to about 80° C. In embodiments, the composition may have a temperature at 50% S′ from about 55° C. to about 90° C., from about 55° C. to about 80° C., from about 65° C. to about 90° C., or even from about 65° C. to about 80° C., or any and all subranges formed from any of these endpoints.

In embodiments, the composition may have a time at 50% S′ greater than or equal to about 100 seconds or even greater than or equal to about 200 seconds. In embodiments, the composition may have a time at 50% S′ less than or equal to about 400 seconds or even less than or equal to about 300 seconds. In embodiments, the composition may have a time at 50% S′ from about 100 seconds to about 400 seconds, from about 100 seconds to about 300 seconds, from about 200 seconds to about 400 seconds, from about 200 seconds to about 300 seconds, or any and all subranges formed from any of these endpoints.

In embodiments, the composition may have a temperature at 90% S′ greater than or equal to about 60° C. or even greater than or equal to about 70° C. In embodiments, the composition may have a temperature at 90% S′ less than or equal to about 95° C. or even less than or equal to about 85° C. In embodiments, the composition may have a temperature at 90% S′ from about 60° C. to about 95° C., from about 60° C. to about 85° C., from about 70° C. to about 95° C., or even from about 70° C. to about 85° C., or any and all subranges formed from any of these endpoints.

In embodiments, the composition may have a time at 90% S′ greater than or equal to about 150 seconds or even greater than or equal to about 250 seconds. In embodiments, the composition may have a time at 90% S′ less than or equal to about 450 seconds or even less than or equal to about 350 seconds. In embodiments, the composition may have a time at 90% S′ from about 150 seconds to about 450 seconds, from about 150 seconds to about 350 seconds, from about 250 seconds to about 450 seconds, from about 250 seconds to about 350 seconds, or any and all subranges formed from any of these endpoints.

In embodiments, the composition may have a viscosity change of less than 200%, less than 175%, or even less than 150%, when aged at 35° C. for 28 days.

In embodiments, the composition may have a viscosity tailored to the intended application for the composition. For example, in a screen-printing application, the viscosity of the composition should be high enough (e.g., greater than or equal to about 5×10⁴ cP) such that the composition can be deposited on the fabric without running. The viscosity of the composition may be limited in screen-printing applications (e.g., less than or equal to about 1×10⁷ cP) such that the composition penetrates the screen when a force is applied. Accordingly, in embodiments, the composition may have a viscosity from about 5×10⁴ cP to about 1×10⁷ cP. In embodiments, the composition may have a viscosity greater than or equal to about 5×10⁴ cP, greater than or equal to about 1×10⁵ cP, greater than or equal to about 1×10⁶ cP, or even greater than or equal to about 2.5×10⁶ cP. In embodiments, the composition may have a viscosity less than or equal to about 1×10⁷ cP, less than or equal to about 7.5×10⁶ cP, or even less than or equal to about 5×10⁶ cP. In embodiments, the composition may have a viscosity from about 5×10⁴ cP to about 1×10⁷ cP, from about 5×10⁴ cP to about 7.5×10⁶ cP, from about 5×10⁴ cP to about 5×10⁶ cP, from about 1×10⁵ cP to about 1×10⁷ cP, from about 1×10⁵ cP to about 7.5×10⁶ cP, from about 1×10⁵ cP to about 5×10⁶ cP, from about 1×10⁶ cP to about 1×10⁷ cP, from about 1×10⁶ cP to about 7.5×10⁶ cP, from about 1×10⁶ cP to about 5×10⁶ cP, from about 2.5×10⁶ cP to about 1×10⁷ cP, from about 2.5×10⁶ cP to about 7.5×10⁶ cP, or even from about 2.5×10⁶ cP to about 5×10⁶ cP, or any and all subranges formed from any of these endpoints.

In embodiments, a weight ratio of the plasticizer to the thermoplastic polymer in the composition may be tailored depending on the intended application of the composition. For example, in screen-printing applications, the composition may be tailored to be printable. Specifically, in screen-printing embodiments, a weight ratio of the plasticizer to the thermoplastic polymer may be, based on the total weight of the composition, from about 0.8:1.0 to about 1.5:1.0 such that the fully cured composition is dry to touch without being tacky and durable to washing and stretching without cracking. In screen-printing embodiments, a weight ratio of the plasticizer to the thermoplastic polymer may be, based on the total weight of the composition, greater than about 0.8:1.0 to ensure the composition flows through and clears the screen. A relatively low plasticizer content may lead to poor shear thinning and poor printability of the composition. In screen-printing embodiments, a weight ratio of the plasticizer to the thermoplastic polymer may be, based on the total weight of the composition, less than about 1.5:1.0 to ensure the printed image has good resolution and fine detail. A relatively higher amount of plasticizer may lead to low viscosity compositions that may continue to flow when pressure is removed, thereby reducing image detail.

Also regarding plastisol coatings, in embodiments, the total amount of inorganic content (e.g., titanium oxide and fillers) of the composition may be limited (i.e., less than about 50 wt %) to ensure the printed composition has sufficient strength. A relatively high inorganic content may lead to breaking or cracking of the printed composition.

### Method of Making Composition

In embodiments, a method of making a composition as described herein may comprise blending the thermoplastic polymer, the plasticizer, and the low melting polymer and mixing to form a liquid dispersion and mixing until the liquid dispersion is homogenous. Color, pigment, dye, and additives, as described herein, may optionally be blended with the thermoplastic polymer, the plasticizer, and the low melting polymer to form the liquid dispersion.

Plastisol dispersions may be made on an overhead mixer with a high shear dispersion blade. In a typical process, the liquid plasticizers and additive are combined in the mixing vessel first under low shear. Pigments and fillers are then added and dispersed with high shear to break up particle aggregates. Finally, the polymer resins are added last and dispersed with medium shear, taking care to avoid the buildup of heat in the vessel. The temperature may be maintained below 95° F./35° C. to avoid pre-gelling the final plastisol composition.

### Method for Making Articles

The compositions disclosed herein may be used to form any coating, binder, adhesive, sealant, protective layer, or the like that requires a lower cure temperature (i.e., cure temperature of less than or equal to about 115° C. The compositions disclosed herein are especially useful for making protective coatings for metal finishes, ultraviolet films for outdoor products, automotive products, and textile inks for screen-printing.

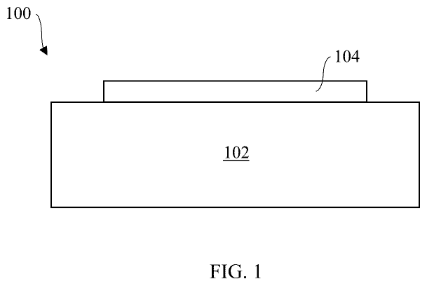

For example, referring now to FIG. 1, an article is shown at 100. The article 100 comprises a substrate 102 with a plastisol coating 104 thereon. The plastisol coating 104 may comprise the composition as disclosed herein. In embodiments, the substrate 102 may comprise textile products including cotton, acrylic, rayon, polyester, nylon, spandex, polypropylene, and other fabric blends. For example, the substrate 102 may comprise a shirt, a jacket, or a bag. In other examples, the substrate 102 may be a paper product, such as posters or cards.

In embodiments, the plastisol coating 104 may have a thickness greater than or equal to about 200 μm, greater than or equal to about 400 μm, or even greater than or equal to about 600 μm. In embodiments, the printing 104 may have a thickness less than or equal to about 2000 μm, less than or equal to about 1500 μm, or even less than or equal to about 1000 μm. In embodiments, the printing 104 may have a thickness from about 200 μm to about 2000 μm, from about 200 μm to about 1500 μm, from about 200 μm to about 1000 μm, from about 400 μm to about 2000 μm, from about 400 μm to about 1500 μm, from about 400 μm to about 1000 μm, from about 600 μm to about 2000 μm, from about 600 μm to about 1500 μm, or even from about 600 μm to about 1000 μm, or any and all subranges formed from any of these endpoints.

In embodiments, a method of plastisol coating the composition as disclosed herein on a substrate may comprise applying the composition to a substrate and exposing the composition to a heat source to fully cure the composition.

In embodiments, the heat source in the exposing step may comprise a gas or electric conveyor oven (i.e., dryer), an electric short wave infrared heater, a heat transfer press, an inline heat press, a heat gun, an iron, or a combination thereof.

In embodiments, the composition may be exposed to the heat source at a temperature of less than about 120° C. In embodiments, the composition may be exposed to the heat source at a temperature of about 93° C. to about 149° C. One skilled in the art would appreciate that the composition may be exposed to a heat source at a temperature greater than the cure temperature if, for example, radiant heat exposure is used as opposed to direct heat exposure. In embodiments, the composition may be exposed to the heat source at a temperature of greater than or equal to about 93° C., greater than or equal to about 100° C., or even greater than or equal to about 110° C. In embodiments, the composition may be exposed to the heat source at a temperature less than or equal to about 149° C., less than or equal to about 140° C., less than or equal to about 130° C., or even less than or equal to about 120° C. In embodiments, the composition may be exposed to the heat source at a temperature from about 93° C. to about 149° C., from about 93° C. to about 140° C., from about 93° C. to about 130° C., from about 93° C. to about 120° C., from about 100° C. to about 149° C., from about 100° C. to about 140° C., from about 100° C. to about 130° C., from about 100° C. to about 120° C., from about 110° C. to about 149° C., from about 110° C. to about 140° C., from about 110° C. to about 130° C., or even from about 110° C. to about 120° C., or any and all subranges formed from any of these endpoints. One skilled in the art would further appreciate that regardless of the heat source, as long as the composition is heated to a temperature at or above the cure temperature (e.g., less than or equal to about 115° C.), the compositions disclosed herein may be cured in any appropriate amount of time.

In embodiments, the composition may be exposed to the heat source for an amount of time necessary to fully cure the composition.

### EXAMPLES

Table 1 shows ingredients and chemical descriptions for Examples Compositions E1-E7 and Comparative Compositions C1-C7.

TABLE 1

| Ingredient | Chemical Description |
|---|---|
| thermoplastic polymer | polyvinyl chloride homopolymer |
| | polyvinyl chloride and vinyl ester copolymer |
| | polyvinyl chloride and vinyl acetate copolymer |
| plasticizer | texanol benzyl cyclohexanoate |
| | 1,2-cyclohexane dicarboxylic acid diisononyl ester |
| | 70:30 blend of dioctyl terephthalate:dibutyl terephthalate |
| | 2,2,4-trimethyl-1,3-pentanediol, dibenzoate |
| | dioctyl terephthalate |
| | C10-C21 alkyl sulfonic acid ester of phenol |
| low melting polymer | copolyester |
| (melting point less than about | thermoplastic polyurethane |
| 120° C.; particle size greater | copolyamide |
| than 0 μm to about 80 μm) | |
| colorant, pigment, or dye | titanium dioxide |
| | (pigment) |

Tables 2 and 3 show the formulations (in wt %, based on total weight of composition) of Example Compositions E1-E7 and Comparative Compositions C1-C3, C6, and C7.

Comparative Compositions C4 and C5 were compositions comprising thermoplastic polymer and plasticizer and lacking a low melting polymer. More specifically, C5 is the composition covered by U.S. Pat. No. 11,193,035.

TABLE 2

| Examples | E1 | E2 | E3 | E4 | E5 | E6 | E7 |
|---|---|---|---|---|---|---|---|
| polyvinyl chloride homopolymer | 12.4 | 12.4 | 13.9 | 10.3 | 10.0 | 9.5 | 9.0 |
| polyvinyl chloride and vinyl | 16.0 | 16.0 | 17.9 | 20.2 | 19.7 | 18.7 | 17.6 |
| ester copolymer | | | | | | | |
| polyvinyl chloride and vinyl | — | — | — | — | — | — | — |
| acetate copolymer | | | | | | | |
| texanol benzyl cyclohexanoate | 15.6 | 15.6 | 17.4 | 20.0 | 19.6 | 18.5 | 17.5 |
| 1,2-cyclohexane dicarboxylic | — | — | — | — | — | — | — |
| acid diisononyl ester | | | | | | | |
| 70:30 blend of dioctyl | — | — | — | 14.0 | 13.7 | 13.0 | 12.2 |
| terephthalate:dibutyl | | | | | | | |
| terephthalate | | | | | | | |
| 2,2,4-trimethyl-1,3- | — | — | — | — | — | — | — |
| pentanediol, dibenzoate | | | | | | | |
| dioctyl terephthalate | — | — | — | — | — | — | — |
| C10-C21 alkyl sulfonic acid | 14.1 | 14.1 | 15.8 | — | — | — | — |
| ester of phenol | | | | | | | |
| copolyester | 15.0 | — | — | 2.8 | 5.0 | 10.0 | 15.0 |
| thermoplastic polyurethane | — | 15.0 | — | — | — | — | — |
| copolyamide | — | — | 5.0 | — | — | — | — |
| titanium dioxide | 26.0 | 26.0 | 29.1 | 31.7 | 30.9 | 29.3 | 27.7 |
| ADDITIVES | 0.9 | 0.9 | 0.9 | 1.0 | 1.1 | 1.0 | 1.0 |

TABLE 3

| Examples | C1 | C2 | C3 | C6 | C7 |
|---|---|---|---|---|---|
| polyvinyl chloride homopolymer | 14.6 | 8.4 | 17.9 | 10.6 | 8.4 |
| polyvinyl chloride and vinyl | 18.8 | 3.6 | 5.9 | 20.7 | 16.6 |
| ester copolymer | | | | | |
| polyvinyl chloride and vinyl | — | 12.1 | — | — | — |
| acetate copolymer | | | | | |
| texanol benzyl cyclohexanoate | 18.4 | — | — | 20.6 | 16.5 |
| 1,2-cyclohexane dicarboxylic | — | 0.1 | 0.1 | — | — |
| acid diisononyl ester | | | | | |
| 70:30 blend of dioctyl | — | — | — | 14.4 | 11.5 |
| terephthalate:dibutyl | | | | | |
| terephthalate | | | | | |
| 2,2,4-trimethyl-1,3- | — | 1.5 | 1.2 | — | — |
| pentanediol, dibenzoate | | | | | |
| dioctyl terephthalate | — | 6.6 | — | — | — |
| C10-C21 alkyl sulfonic acid | 16.6 | 15.9 | 24.9 | — | — |
| ester of phenol | | | | | |
| copolyester | — | — | — | — | 20.0 |
| thermoplastic polyurethane | — | — | — | — | — |
| copolyamide | — | — | — | — | — |
| titanium dioxide | 30.6 | 28.9 | 28.5 | 32.6 | 26.1 |
| ADDITIVES | 1.0 | 22.9 | 21.5 | 1.1 | 0.9 |

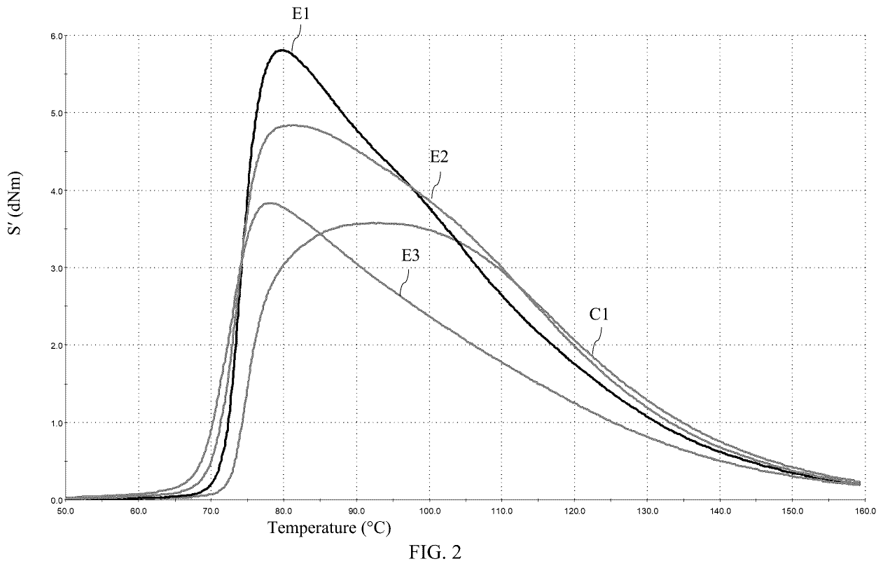

Referring now to FIG. 2 and Table 4, Example Compositions E1-E3, compositions including copolyester, thermoplastic polyurethane, and copolyamide, respectively (low melting polymer), had a temp at max. S′ of 79.49° C., 77.93° C., and 80.45° C., respectively. Moreover, Example Compositions E1-E3, had a lower temperature at maximum S′ and time at maximum S′ than Comparative Composition C1, a composition lacking a low melting polymer.

TABLE 4

| | C1 | E1 | E2 | E3 |
|---|---|---|---|---|
| S′ at 60° C. (dNm) | 0.02 | 0.02 | 0.08 | 0.05 |
| Temp. at 10% S′ (° C.) | 72.90 | 71.52 | 68.09 | 69.92 |
| Time at 10% S′ (s) | 258 | 244 | 208 | 227 |
| Temp. at 50% S′ (° C.) | 75.52 | 74.04 | 72.10 | 73.29 |
| Time at 50% S′ (s) | 288 | 272 | 250 | 263 |
| Temp. at 90% S′ (° C.) | 81.79 | 76.72 | 75.06 | 76.21 |
| Time at 90% S′ (s) | 355 | 300 | 284 | 296 |
| Max. S′ (dNm) | 3.58 | 5.81 | 3.84 | 4.84 |
| Temp. at max. S′ (° C.) | 92.34 | 79.49 | 77.93 | 80.45 |
| Time at max. S′ (s) | 470 | 331 | 314 | 340 |

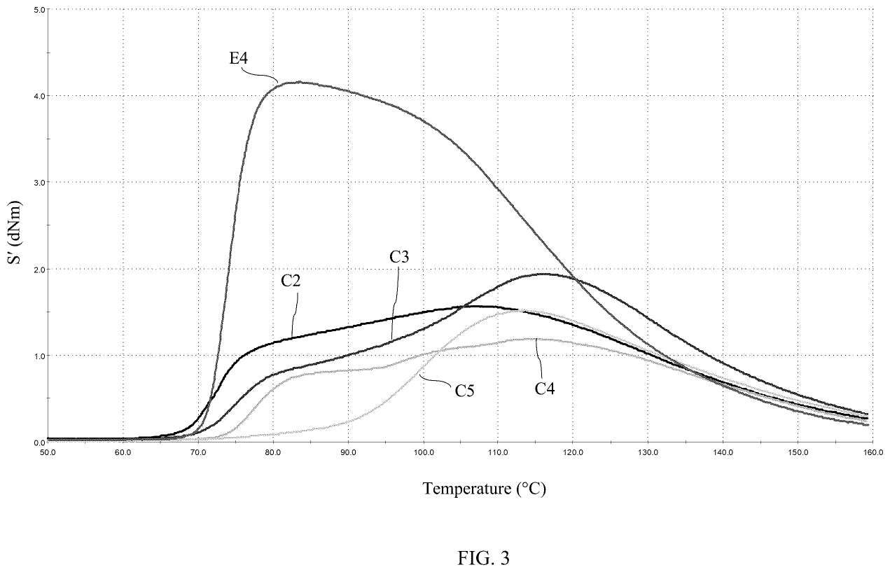

Referring now to FIG. 3 and Table 5, Example Compositions E4, a composition including copolyester (low melting polymer), had a temp at max. S′ of 83.17° C. Moreover, Example Composition E4, had a lower temperature at maximum S′ and time at maximum S′ than Comparative Compositions C1-C5, compositions lacking a low melting polymer.

TABLE 5

| | C2 | C3 | C4 | C5 | E4 |
|---|---|---|---|---|---|
| S′ at 60° C. (dNm) | 0.04 | 0.02 | 0.02 | 0.02 | 0.02 |
| Temp. at 10% S′ (° C.) | 69.06 | 72.33 | 74.39 | 86.87 | 71.44 |
| Time at 10% S′ (s) | 218 | 251 | 276 | 408 | 240 |
| Temp. at 50% S′ (° C.) | 73.88 | 88.92 | 79.87 | 98.88 | 74.15 |
| Time at 50% S′ (s) | 269 | 433 | 334 | 539 | 270 |
| Temp. at 90% S′ (° C.) | 95.06 | 108.88 | 103.47 | 107.01 | 77.44 |
| Time at 90% S′ (s) | 499 | 650 | 589.8 | 628 | 306 |
| Max. S′ (dNm) | 1.57 | 1.94 | 1.19 | 1.52 | 4.16 |
| Temp. at max. S′ (° C.) | 106.4 | 115.55 | 113.51 | 113.07 | 83.17 |
| Time at max. S′ (s) | 623 | 722 | 700 | 693 | 367 |

As exemplified by FIGS. 2 and 3 and Tables 4 and 5, compositions including a low melting polymer have reduced cure temperature and measured cure time as compared to a composition lacking a low melting polymer.

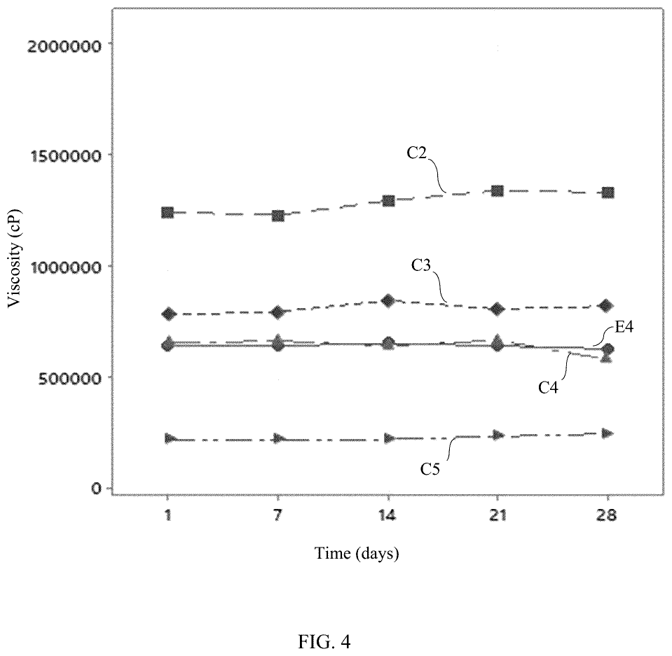

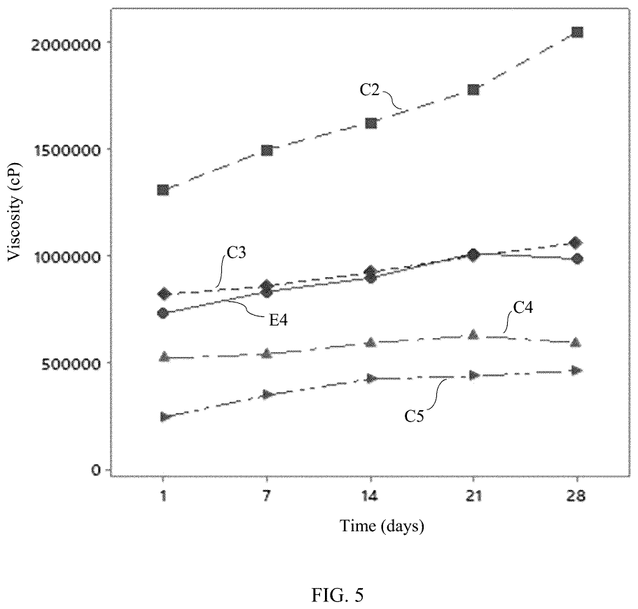

Referring now to Table 6 and FIGS. 4 and 5, the storage stabilities of Comparative Compositions C2-C5 and Example Composition E4 were evaluated by aging the compositions at 25° C. (as shown in FIG. 4) and at 35° C. (as shown in FIG. 5 and Table 6) by measuring the viscosity of the compositions at different times. As shown in FIG. 4, the variations in viscosity between Comparative Compositions C2-C5, compositions lacking a low melting polymer, and Example Composition E4, a composition including a low melting polymer, when subjected to heat aging 25° C. were similar. As shown in FIG. 5 and Table 6, Example Composition E4 had a 135% viscosity change. Moreover, the variations in viscosity between Comparative Compositions C3 and C4 and Example Composition E4, were similar, but Comparative Compositions C2 and C5 had a relatively greater variation in viscosity as compared to Comparative Composition C3 and Example Composition E4. While not wishing to be bound by theory, Comparative Compositions C2 and C5 began to gel at low temperatures (i.e., relatively low S′ at 60° C.), leading to increased viscosity as the material is heat aged. As exemplified by FIGS. 4 and 5 and Table 6, compositions including a low melting polymer have maintained storage stability,

TABLE 6

| | C2 | C3 | C4 | C5 | E4 |
|---|---|---|---|---|---|
| Viscosity on | 1.036 × 10⁶ | 8.192 × 10⁵ | 5.18 × 10⁵ | 2.432 × 10⁵ | 7.296 × 10⁵ |
| Day 1 (cP) | | | | | |
| Viscosity on | 2.048 × 10⁶ | 1.062 × 10⁶ | 5.90 × 10⁵ | 4.608 × 10⁵ | 9.856 × 10⁵ |
| Day 28 (cP) | | | | | |
| Viscosity | 157 | 130 | 114 | 189 | 135 |
| Change (%) | | | | | |

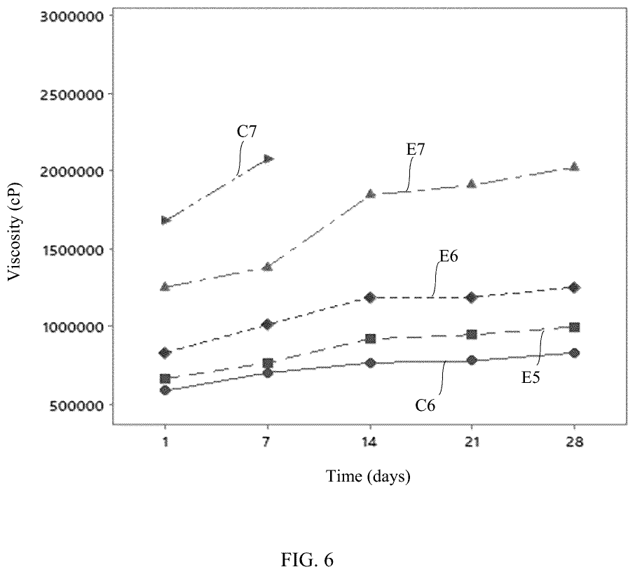

Referring now to Table 7 and FIG. 5, the storage stabilities of Comparative Compositions C6 and C7 and Example Compositions E5-E7 were evaluated by heat aging the compositions at 35° C. and measuring the viscosity of the compositions at different times. As shown in Table 7 and FIG. 6, while Example Composition E7, a composition including 15 wt % copolyester (low melting polymer), had a relatively high viscosity, the composition still achieved a maintained storage stability. Moreover, Comparative Composition C7, a composition including 20 wt % copolyester (low melting polymer) gelled (i.e., became a semi-solid) after 14 days of heat aging at 35° C. As exemplified by FIGS. 3 and 4 and Table 6, compositions including about 0.2 wt % to about 19 wt % low melting polymer as described herein have maintained storage stability.

TABLE 7

| | C6 | C7 | E5 | E6 | E7 |
|---|---|---|---|---|---|
| Viscosity on | 5.888 × 10⁵ | 1.677 × 10⁶ | 6.656 × 10⁵ | 8.32 × 10⁵ | 1.256 × 10⁶ |
| Day 1 (cP) | | | | | |
| Viscosity on | 8.32 × 10⁵ | — | 9.984 × 10⁵ | 1.254 × 10⁵ | 2.022 × 10⁶ |
| Day 28 (cP) | | | | | |
| Viscosity | 141 | — | 150 | 151 | 161 |
| Change (%) | | | | | |

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A composition comprising:
(a) a thermoplastic polymer;
(b) a plasticizer; and
(c) about 0.2 wt % to about 19 wt % of a low melting polymer, based on a total weight of the composition, the low melting polymer having a melting point less than about 120° C.

2. The composition of claim 1, wherein the thermoplastic polymer comprises polyvinyl chloride homopolymer, polyvinyl chloride and vinyl ester copolymer, or a combination thereof.

3. The composition of claim 1, wherein the plasticizer comprises terephthalate, cyclohexonate, benzoate, dibenzoate, adipate, citrate, trimelitate, alkyl sufonic acid ester, or a combination thereof.

4. The composition of any one of claim 1, wherein the plasticizer comprises dibutyl terephthalate; dioctyl terephthalate; benzyl 3-(isobutyryloxy)-2,2,4-trimethylpentyl cyclohexane-1,2-dicarboxylate; butyl benzyl cyclohexanoate; texanol benzy cyclohexanoate; 1,2-cyclohexane dicarboxylic acid diisononyl ester; 2,2,4-trimethyl-1,3-pentanediol, dibenzoate; and 1,2-cyclohexanedicarboxylic acid, 1-(phenylmethyl) ester, ester with 2,2,4-trimethyl-1,3-pentanediol mono(2-methylpropanoate), or a combination thereof.

5. The composition of claim 4, wherein the plasticizer comprises dioctyl terephthalate; dibutyl terephthalate; and 1,2-cyclohexanedicarboxylic acid, 1-(phenylmethyl) ester, ester with 2,2,4-trimethyl-1,3-pentanediol mono(2-methylpropanoate).

6. The composition of claim 5, wherein a weight ratio of dioctyl terephthalate to dibutyl terephthalate to 1,2-cyclohexanedicarboxylic acid, 1-(phenylmethyl) ester, ester with 2,2,4-trimethyl-1,3-pentanediol mono(2-methylpropanoate) is, based on the total weight of the composition, from about 0.28:0.12:1.00 to about 0.7:0.3:1.0.

7. The composition of claim 1, wherein the low melting polymer comprises polyester, copolyester, copolyamide, polyamide, thermoplastic polyurethane, or a combination thereof.

8. The composition of claim 1, wherein the low melting polymer has a particle size from greater than 0 μm to about 80 μm.

9. The composition of claim 1, wherein the composition has a viscosity from about 5×10⁴ cP to about 1×10⁷ cP.

10. The composition of claim 1, wherein the thermoplastic polymer is combination of polyvinyl chloride homopolymer and polyvinyl chloride and vinyl ester copolymer.

11. The composition of claim 10, wherein a weight ratio of polyvinyl chloride and vinyl ester copolymer to polyvinyl chloride homopolymer is, based on the total weight of the composition, from about 1:1 to about 10:1.

12. The composition of claim 1, wherein a weight ratio of the plasticizer to the thermoplastic polymer is, based on the total weight of the composition, from about 0.8:1.0 to about 1.5:1.0.

13. The composition of claim 1, wherein the composition comprises, based on the total weight of the composition:
about 20 wt % to about 45 wt % of the thermoplastic polymer; and
about 20 wt % to about 45 wt % of the plasticizer.

14. The composition of claim 1, wherein the composition further comprises, based on the total weight of the composition, greater than about 0 wt % to about 45 wt % of at least one of colorant, pigment, and dye.

15. The composition of claim 14, wherein the at least one of colorant, pigment, and dye comprises titanium dioxides, carbon blacks, azo pigments, copper phthalocyanine pigments, carbozoles, or a combination thereof.

16. The composition of claim 1, wherein the composition further comprises, based on the total weight of the composition, greater than about 0 wt % to about 10 wt % additives, the additives comprising dispersants, fillers, lubricants, puff matting agents, antioxidants, chemical and physical blowing agents, stabilizers, moisture scavengers, air release agents, oxidizers, reducers, thickeners, emulsifiers, rheology modifiers, catalysts, or a combination thereof.

17. An article comprising a substrate with a plastisol coating thereon, the plastisol coating comprising the composition of claim 1.

18. A method of plastisol coating the composition of claim 1 on a substrate, the method comprising:
applying the composition to a substrate; and
exposing the composition to a heat source to fully cure the composition.

19. The method of claim 18, wherein the composition is exposed to the heat source at a temperature of less than about 120° C.

20. The method of claim 18, wherein the composition is exposed to the heat source at a temperature of about 83° C. to about 149° C.
